(19) United States
(12) Patent Application Publication
(10) Pub. No.: US 2010/0208457 A1
(43) Pub. Date: Aug. 19, 2010

(54) LIGHT EMITTING DIODE LAMP

(76) Inventor: Sung-Hwan Keal, Seoul (KR)

Correspondence Address: LAW OFFICE OF DELIO & PETERSON, LLC., 121 WHITNEY AVENUE, NEW HAVEN, CT, 06510, US

(21) Appl. No.: 12/676,512

(22) PCT Filed: Sep. 5, 2008
(86) PCT No.: PCT/KR2008/005242

§ 371 Date: Mar. 4, 2010

(30) Foreign Application Priority Data
Sep. 5, 2007 (KR) 10-2007-0089783
Jul. 10, 2008 (KR) 10-2008-0066964

(51) Int. Cl. F21V 29/00

(52) U.S. Cl. 362/234

(57) ABSTRACT

Disclosed is an LED lamp, which has a water cooling-type radiating structure of a high brightness LED lamp so as to allow heat generated according to operation of the LED to be effectively emitted so that superior intensity of radiation can be secured. The LED lamp includes: a refrigerant storage member, which has a predetermined space part formed in an airtight interior of the refrigerant storage member and stores refrigerant for radiation in the space part, the refrigerant storage member having a cylindrical shape; and PCB substrates, which have a plurality of high brightness LEDs installed at each upper surface of the PCB substrates and are attached onto an outer circumferential surface of the refrigerant storage member by means of a radiating tape in such a manner that the PCB substrates surround the outer circumferential surface in a state where the LEDs are designed to be supplied with power.

### TECHNICAL FIELD

The present invention relates to an light emitting diode (LED) lamp, and more particularly to an LED lamp, in which a radiating structure included in a high brightness LED lamp is implemented by means of a water cooling method, so that the radiating structure remarkably increases efficiency of radiation and an LED lamp including a high brightness LED can be substituted for (can be used in place of; can replace) various kinds of electric lamps, fluorescent lamps, and street lamps, etc.

### BACKGROUND ART

In general, an LED radiates in such a manner that minority carriers (electronics or holes), which have been injected by using a p-n connection structure of a semiconductor, are formed and re-coupled with each other.

In present, various products applying an LED have been developed and are used in various industry fields. Particularly, a high brightness LED lamp has an advantage in that a life span is semi-permanent, and consumption power is very low. Therefore, it is expected that a high brightness LED lamp can be substituted for various kinds of electric lamps including conventional fluorescent lamps, incandescent lamps, sodium lamps, mercury lamps, etc.

That is, as such LED lamps are substituted for conventional electronic lamps, which include various kinds of harmful materials and have a short lifetime, it is possible to obtain an effect on decreasing environmental pollution. Also, due to low power consumption of the LED lamp, energy consumption can be reduced.

A conventional LED lamp includes a substrate made from aluminum material, which has one or a plurality of high brightness LEDs and is designed to supply power to the LED, and a radiating member made from aluminum material, the radiating member being assembled with a rear side of the substrate and including radiating plates having a predetermined shape. The LED lamp has a structure allowing heat generated according to operation of the LED to be emitted to atmosphere by means of the substrate made from aluminum material and the radiating member.

However, there is a limitation in that heat generated in operation of the LED lamp is emitted by an air-cooling method as described above. In a case where the volume of the radiating member increases in order to overcome this limitation, there is a problem in that it is difficult to satisfy volume, weight, cost, etc. of a product.

Particularly, in a high power LED lamp, which has power from about 0.5 [W] to about 5 [W] and is structured in such a manner that more sufficient intensity of radiation can be obtained, the temperature of heat generated in operation of the LED reaches approximately 60° C.-100° C. Because of this, an LED chip continuously becomes stressed so that intensity of radiation is reduced. Accordingly, there is a problem in that application of the LED lamp is very limited.

### DISCLOSURE

### Technical Problem

The present invention has been made in view of the above-mentioned problems, and the present invention provides an LED lamp, which has a water cooling-type radiating structure of a high brightness LED lamp so as to allow heat generated according to operation of the LED to be effectively emitted so that superior intensity of radiation can be secured.

That is, a water cooling-type radiating structure is applied to a high brightness LED lamp so that the temperature of emitting heat is lowered below 50° C. As a result, a larger number of LEDs is included in the lamp without any effect on the life time of the LED so that it is possible to substitute the LED lamp for various kinds of conventional electric lamps.

### Technical Solution

In accordance with an aspect of the present invention, there is provided an LED lamp including: a refrigerant storage member, which has a predetermined space formed in an airtight interior of the refrigerant storage member and stores refrigerant for radiation in the space part, the refrigerant storage member having a cylindrical shape; and PCB substrates, which have a plurality of high brightness LEDs installed at each upper surface of the PCB substrates and are attached onto an outer circumferential surface of the refrigerant storage member by means of a radiating tape in such a manner that the PCB substrates surround the outer circumferential surface in a state where the LEDs are designed to be supplied with power.

### ADVANTAGEOUS EFFECTS

According to the preset invention structured as described above, a high brightness LED lamp has a water cooling-type radiating structure so as to allow heat to be effectively emitted. As a result, it is possible to solve a problem that sufficient intensity of radiation can not be provided due to a radiation problem of the high brightness LED lamp. Also, due to this advantage, the range of application of LED lamps can be remarkably enlarged.

That is, thanks to this advantage, the high brightness LED lamp can be substituted for various lighting fields requiring an optical source, such as incandescent lamps, fluorescent lamps, street lamps, lighthouses, lamps for work, etc. Therefore, there are very useful economic effects according to the characteristic of the high brightness LED lamp, such as a long lifetime, energy saving, etc.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view of an LED lamp according to a first embodiment of the present invention;

FIG. 2 is a perspective view of a modified LED lamp according to the first embodiment of the present invention;

FIG. 3 is a perspective view of another modified LED lamp according to the first embodiment of the present invention;

FIG. 4 is a perspective view of an LED lamp according to a second embodiment of the present invention;

FIG. 5 is a perspective view of a modified LEI) lamp according to the second embodiment of the present invention;

FIG. 6 is a sectional view taken along the line A-A′ of FIG. 5;

FIG. 7 is an exploded perspective view of a modified LED lamp according to the second embodiment of the present invention;

FIG. 8 is a perspective view of another modified LED lamp according to the second embodiment of the present invention;

FIGS. 9a and 9b are perspective views of an LED lamp according to a third embodiment of the present invention;

FIG. 10 is a perspective view of a modified LED lamp according to the third embodiment of the present invention;

FIG. 11 is a perspective view of another modified LED lamp according to the third embodiment of the present invention;

FIG. 12a is a perspective view of an LED lamp according to a fourth embodiment of the present invention;

FIG. 12b is a cut-away perspective view of an LED lamp according to the fourth embodiment of the present invention;

FIG. 12c is a partial sectional view of an LED lamp according to the fourth embodiment of the present invention;

FIG. 13a is a perspective view of a modified LED lamp according to the fourth embodiment of the present invention;

FIG. 13b is a cut-away perspective view of a modified LED lamp according to the fourth embodiment of the present invention;

FIG. 13c is a partial sectional view of a modified LED lamp according to the fourth embodiment of the present invention;

FIG. 14a is a perspective view of an LED lamp according to a fifth embodiment of the present invention;

FIG. 14b is front sectional view of an LED lamp according to the fifth embodiment of the present invention;

FIG. 15a is a perspective view of an LED lamp according to a sixth embodiment of the present invention;

FIG. 15b is a partial sectional view of an LED lamp according to the sixth embodiment of the present invention; and

FIG. 16 is a partial sectional view of a modified LED lamp according to the sixth embodiment of the present invention.

### BEST MODE

### Mode for Invention

Hereinafter, exemplary embodiments of the present invention will be described with reference to the accompanying drawings.

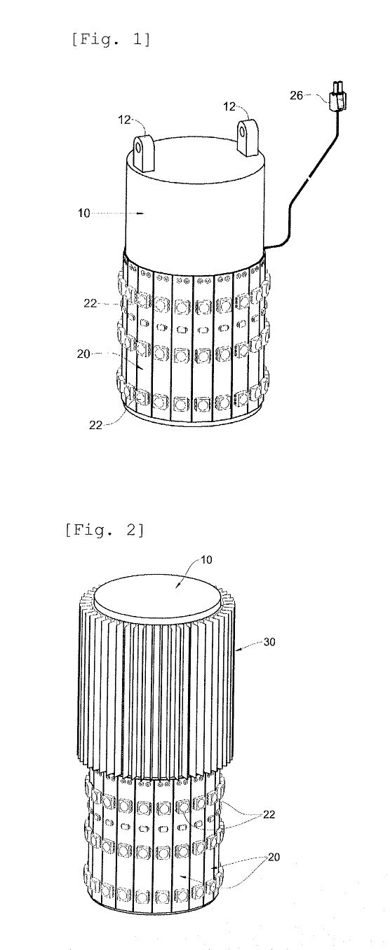

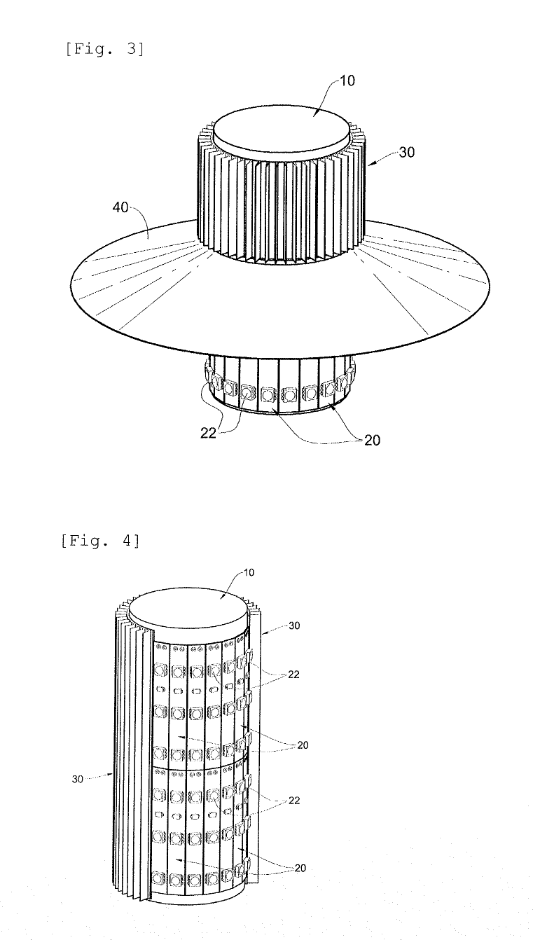

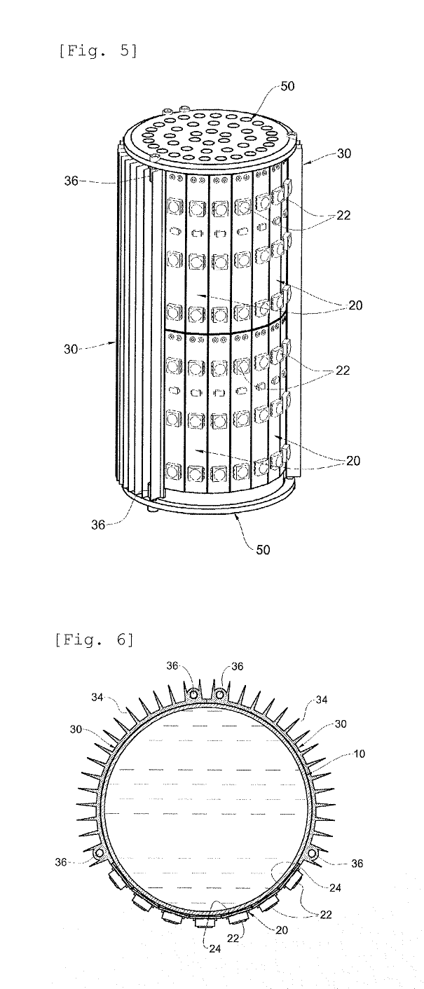

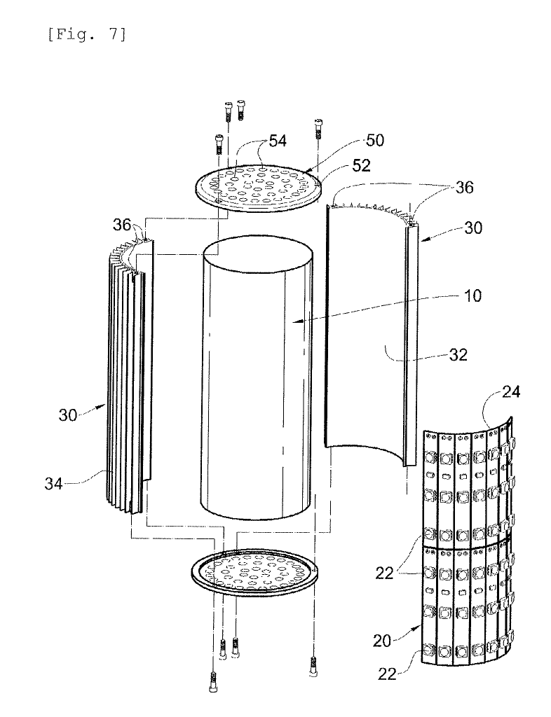

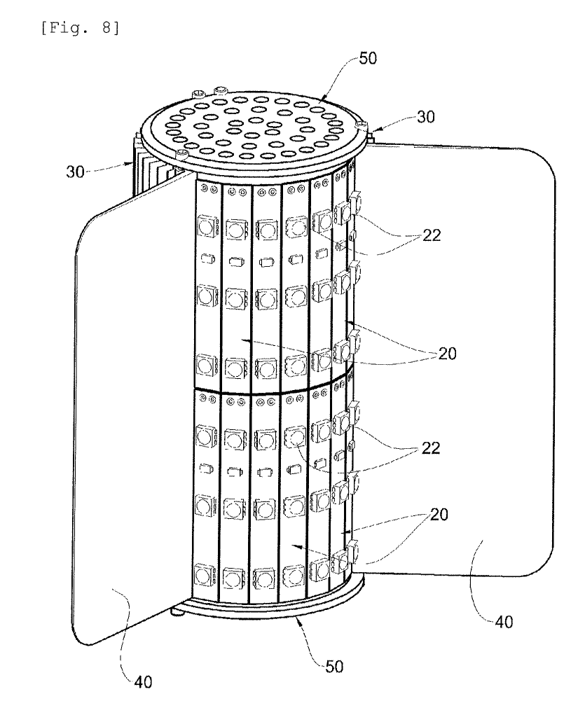

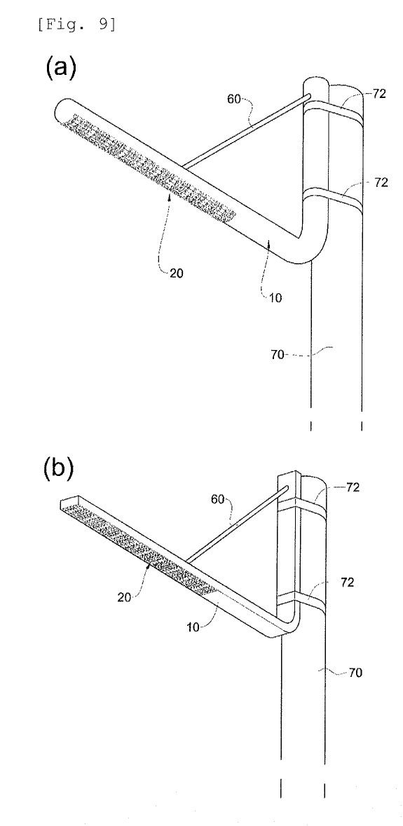

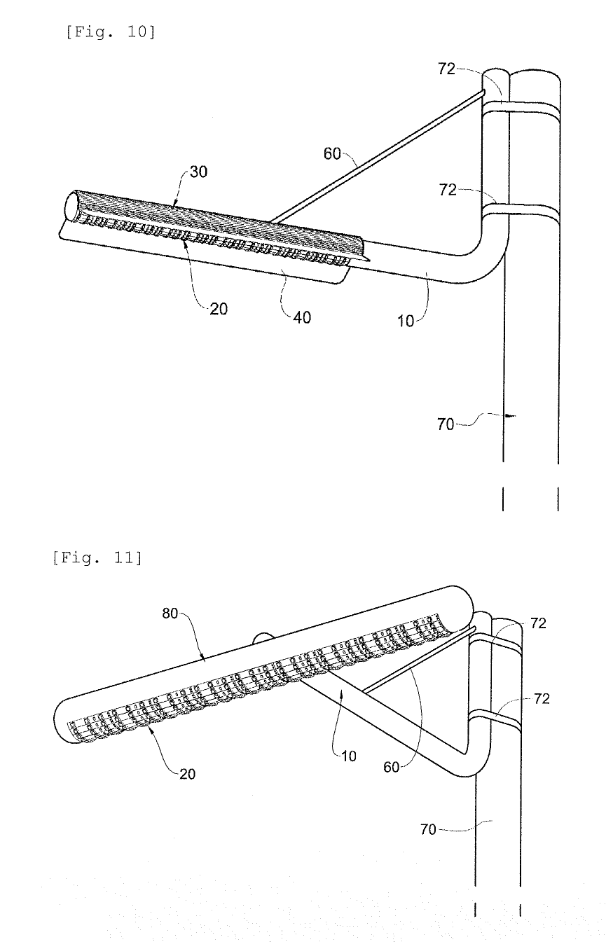

FIG. 1 is a perspective view of an LED lamp according to a first embodiment of the present invention, FIG. 2 is a perspective view of a modified LED lamp according to the first embodiment of the present invention, FIG. 3 is a perspective view of another modified LED lamp according to the first embodiment of the present invention, FIG. 4 is a perspective view of an LED lamp according to a second embodiment of the present invention, and FIG. 5 is a perspective view of a modified LED lamp according to the second embodiment of the present invention. Also, FIG. 6 is a sectional view taken along the line A-A′ of FIG. 5, FIG. 7 is an exploded perspective view of a modified LED lamp according to the second embodiment of the present invention, FIG. 8 is a perspective view of another modified LED lamp according to the second embodiment of the present invention, FIGS. 9a and 9b are perspective views of an LED lamp according to a third embodiment of the present invention, FIG. 10 is a perspective view of a modified LED lamp according to the third embodiment of the present invention, and FIG. 11 is a perspective view of another modified LED lamp according to the third embodiment of the present invention.

First, as shown in FIGS. 1 to 3, an LED lamp according to the first embodiment of the present invention has an approximately cylindrical shape and has a space in the inside thereof. Also, the LED lamp includes a plurality of high brightness LEDs 22 and a radiating member 30, which are formed at an outer surface of a refrigerant storage member 10 for storing a predetermined refrigerant for radiation.

That is, in a state where the refrigerant storage member 10 keeps refrigerant for radiation, such as water, oil, etc., the refrigerant storage member 10 includes a plurality of PCB substrates 20 in a belt-shape, which is attached to a lower part of an outer circumferential surface of the refrigerant storage member 10 by means of radiating tapes in such a manner that they surround the lower part. Each PCB substrate has a plurality of high brightness LEDs 22 formed on an upper surface thereof.

At this time, an assembling bracket 12 for installation of the LED lamp protrudes from one side of the refrigerant storage member 10. Also, the plurality of substrates 20 is connected with a power part 26 provided with a predetermined power from the outside. It can be understood that the design of each configuration of the power part 26 and assembling bracket 12 can be variously changed according to the shape and size of the LED lamp.

Moreover, a radiating member 30, which including a body 32 having a pipe-shape and radiating plates 34 of a protruding shape, which extend from an outer circumferential surface of the body 32, are attached onto an upper part, which the substrate 20 does not surround, of an outer circumferential surface of the refrigerant storage member 10. As a result, radiation efficiency can be maximized.

Also, a lamp shade 40 is formed along an outer circumferential surface of a boundary between the substrate 20 and the radiating member 30, which are formed on the outer circumferential surface of the refrigerant storage member 10, so that light of each high-brightness LED 22 formed at the substrate 20 can be efficiently irradiated to the lower side.

As shown in FIGS. 4 to 8, the LED lamp according to the second embodiment of the present invention has a roughly cylindrical shape and has a predetermined space formed at the inside thereof. Also, the LED lamp includes a plurality of high brightness LEDs 22 and a radiating member 30, which are formed along a longitudinal direction of an outer surface of a refrigerant storage member 10 for storing a predetermined refrigerant for radiation.

Accordingly, a PCB substrate 20 having a plurality of high-brightness LEDs 22 formed on an upper surface thereof is attached onto a part of an outer circumferential surface of the refrigerant storage member 10 of a cylindrical shape along a longitudinal direction of the refrigerant storage member. Meanwhile, a radiating member 39, which includes a body 32 in a sectional shape of a rough semi-circle and radiating plates 34 having a protruding shape, which extend from the outer circumferential surface of the body, are formed on a part of the outer circumferential surface of the refrigerant storage member 10, onto which the substrate 20 is not attached.

At this time, the substrate 20 is attached onto a part of the outer circumferential surface of the refrigerant storage member 10, the part being formed at 120 degrees. The radiating member 30 is constituted of a pair of members, and each member is attached onto each part of the outer circumferential surface of the refrigerant storage member, each part being formed at 120 degrees. Each lamp shade is formed in such a manner that the width of one of the radiating plates 34 positioned at a lowest end of the radiating member 30 extends out.

Also, finishing members 50 having a disc-shape are fixed at both ends of the refrigerant storage member 10 so as to perform a plug function, protecting the refrigerant storage member 10. Each finishing member 50 has a rough disc-shape and has a plurality of assembling holes 52 formed at an edge thereof and a plurality of emitting holes 54 formed at the central part thereof.

Moreover, in order to fix the finishing members 50, a plurality of assembling members 36 is formed between the radiating plates 34 positioned at both ends of each radiating member 30 attached onto the refrigerant storage member 10, respectively, in such a manner that the assembling members correspond to the assembling holes 52 of the finishing member 50. Therefore, the finishing members 50 are installed at the both ends of the refrigerant storage member 10 by means of screws assembled through the assembling holes 52 and the assembling members 36.

Meanwhile, as shown in FIGS. 9a and 9b to 11, in the LEI) lamp according to the third embodiment of the present invention, a substrate 20 having a plurality of high-brightness LEDs 22 is attached onto a refrigerant storage member 10 having a specific shape, and the refrigerant storage member 10 is fixedly installed on a telephone pole, a post 70, etc. Accordingly, the LED lamp can be implemented.

Herein, the refrigerant storage member 10 fixedly installed at the telephone pole or the post 70 has a front surface of a rough shape of [symbol] and has a section of a circular shape or a rectangular shape. Also, a predetermined space is formed at a closed interior of the refrigerant storage member 10 so as to allow refrigerant, such as water, oil, etc. for radiation to be stored in the space.

Also, in a state where a substrate 20 having a plurality of high-brightness LEDs 22 is attached onto an outer circumferential surface of a lower side of the refrigerant storage member 10 having the section of a circular shape or a lower surface of the refrigerant storage member 10 having a section of a rectangular shape, the refrigerant storage member 10 is fixedly installed at an upper side of the telephone pole or the post 70, which has a predetermined height, by using steel bands 72.

Also, both ends of the reinforcing member 60 are assembled with both ends of the refrigerant storage member 10 so that a stronger structure is formed.

At this time, after a separate extending member 80 integrally extends from the refrigerant storage member 10, the substrate 20 having a plurality of high brightness LEDs 22 may be attached onto a lower part of the extending member 80.

That is, the extending member 80 integrally extends from a front end of the refrigerant storage member 10 in such a manner that the inner space of the extending member communicates with the inner space of the refrigerant storage member so that the entire plane of the refrigerant storage member 10 has a rough shape of “├”.

Also, the radiating member 30 and the lamp shade 40, which are described above, according to the first and second embodiments of the present invention may be additionally formed at parts of the refrigerant storage member 10 and the extending member 80, etc., onto which the substrate 20 is not attached.

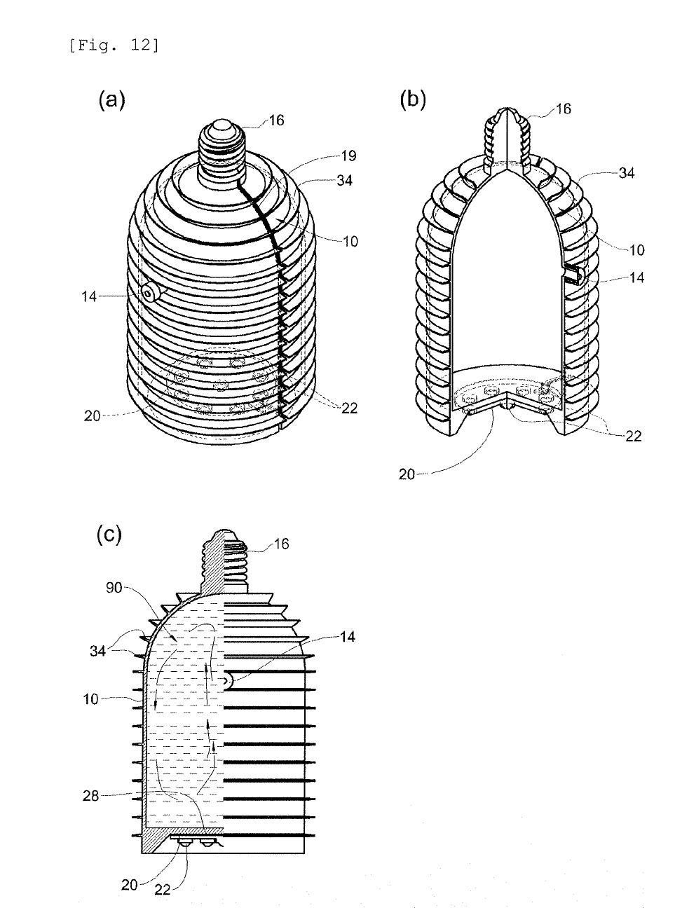

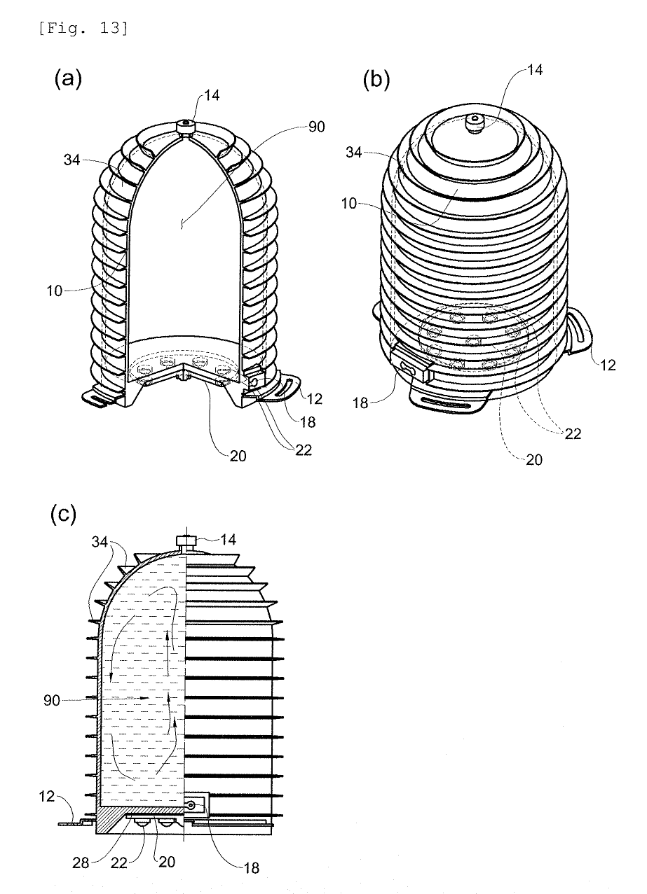

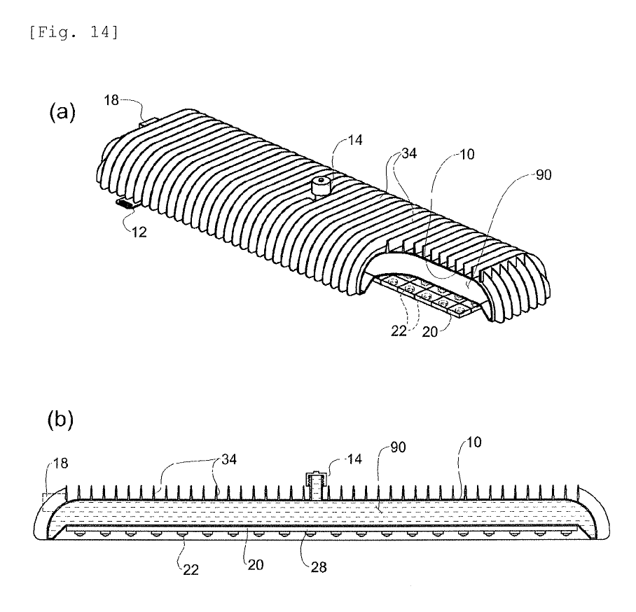

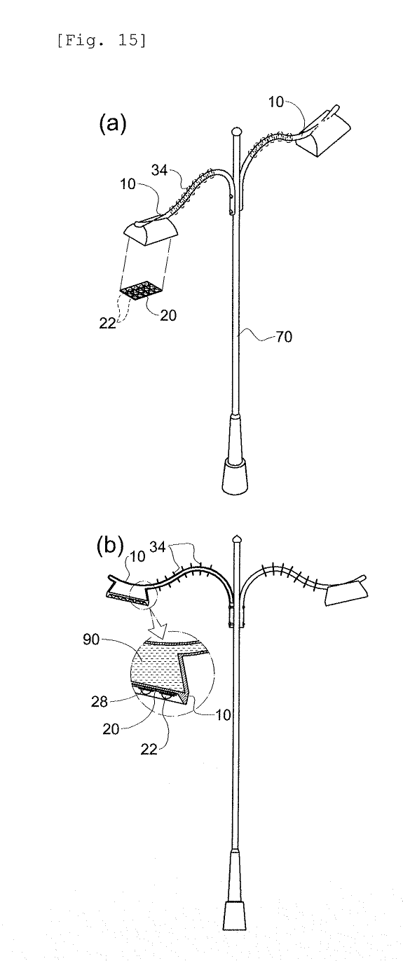

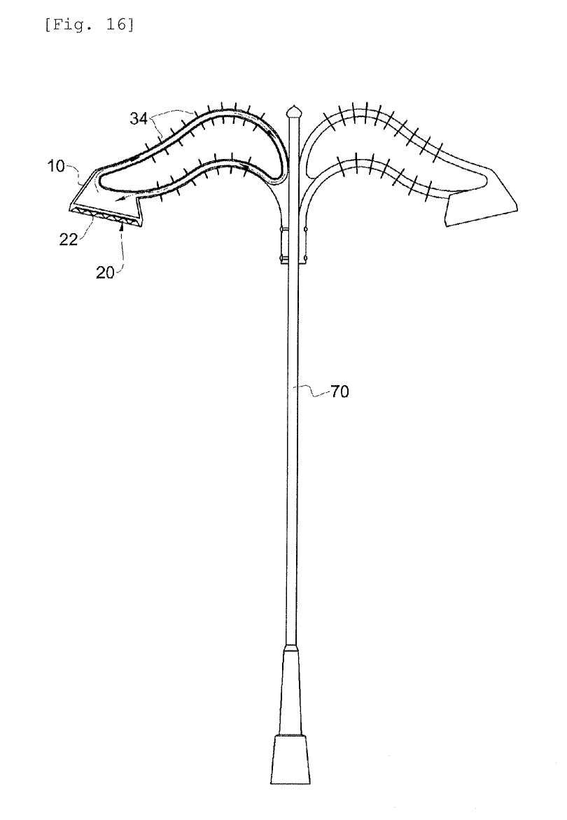

FIG. 12a is a perspective view of an LED lamp according to a fourth embodiment of the present invention, FIG. 12b is a cut-away perspective view of an LED lamp according to the fourth embodiment of the present invention, FIG. 12c is a partial sectional view of an LED lamp according to the fourth embodiment of the present invention, FIG. 13a is a perspective view of the modified LED lamp according to the fourth embodiment of the present invention, FIG. 13b is a cut-away perspective view of a modified LED lamp according to the fourth embodiment of the present invention, FIG. 13c is a partial sectional view of the modified LED lamp according to the fourth embodiment of the present invention. Also, FIG. 14a is a perspective view of an LED lamp according to a fifth embodiment of the present invention, FIG. 14b is front sectional view of an LED lamp according to the fifth embodiment of the present invention, FIG. 15a is a perspective view of an LED lamp according to a sixth embodiment of the present invention, FIG. 15b is a partial sectional view of an LED lamp according to the sixth embodiment of the present invention; and FIG. 16 is a partial sectional view of a modified LED lamp according to the sixth embodiment of the present invention.

As shown, the LED lamp according to the fourth to sixth embodiments of the present invention has various shapes, includes a refrigerant storage member 10 having a predetermined space formed in an airtight interior of the refrigerant storage member so as to allow refrigerant 90 to be stored in the space, and also includes a substrate 20, which is formed by a plate made from aluminum material, has one high brightness LED 22 to a plurality of high brightness LEDs 22, and is fixedly installed at a lower surface of the refrigerant storage member 10 in a state where the LED is designed to be provided with power.

In order to allow the LED lamp to be substituted for an incandescent lamp, in a state where the refrigerant storage member 10 has a rough bottle-shape, the LED lamp according to the fourth embodiment of the present invention shown in FIGS. 12a to 12c has an assembling part 16 having an upper part, on which a screw thread is formed, so as to be assembled with a socket, with which the incandescent lamp is assembled.

Also, the substrate 20 having high-brightness LEDs 22 formed thereon is attached onto a lower surface of the refrigerant storage member 10. The assembling part 16 is connected with the substrate 20 by means of a connecting wire 19 so as to supply predetermined power to the LED 22. Also, a converter (not shown) is included in the substrate 20 so as to convert high voltage of 220 [V] inputted through the assembling part 16 to low voltage of 12 [V] required for driving the LEDs 22.

At this time, the LEDs 22 installed at the substrate 20 may be variously formed within a range from 0.5[W] to 5 [W] according to the purpose of use, and it is understood that the number of LEDs can be changed from one to multiple ones in design.

Also, the refrigerant storage member 10 is made from metal material, such as copper, titanium, aluminum, etc. Also, refrigerant 90 stored within the refrigerant storage member may be liquid, such as an antifreezing solution, distilled water, ionized water, etc.

Moreover, a plurality of radiating plates 34 is integrally formed at an outer surface of the refrigerant storage member, the radiating plates being made from material equal to the material of the refrigerant storage member, so as to increase the water cooling-type radiation effect through the refrigerant 90. Radiating grease 28 is included between the refrigerant storage member 10 and the substrate 20 so that it is possible to maximize radiation effect of the substrate 20.

Moreover, an opening/closing member 14 may be included in one side of a body of the refrigerant storage member 10 or a predetermined position of an upper end of the refrigerant storage member so as to allow refrigerant 90 of the interior of the refrigerant storage member to be supplemented or replaced.

The LED lamp according to the modified embodiment of the present invention, which is shown in FIGS. 13a to 13c, includes a pair of assembling brackets 12 protruding from one side of the refrigerant storage member 10 so as to allow the LED lamp to be directly installed at a spot, at which a socket for an incandescent lamp, etc. is not installed.

Moreover, a power input part 18, which is electrically connected with the substrate 20, is included in one side of the refrigerant storage member 10 so as to directly supply DC power of 12 [V] to the LEDs 22 by means of an adapter, etc.

Meanwhile, according to the fifth embodiment of the present invention shown in FIGS. 14a and 14b, the LED lamp has a refrigerant storage member 10 having a roughly broad and cuboidal shape or a broad and cylindrical shape so as to be substituted for a fluorescent lamp, a decoration lamp used in a living room, etc.

At this time, a plurality of assembling brackets 12 for installing a body of the refrigerant storage member is formed at one side of the refrigerant storage member 10. Also, the substrates 20 including the LEDs 22, which emit light by means of power from the power part, are formed at a lower surface of the refrigerant storage member 10. A plurality of substrates 20 is arranged at the lower surface of the refrigerant storage member 10.

Also, in order to increase the radiation effect, a plurality of radiating plates 34 is integrally formed at an outer surface of the refrigerant storage member 10, and radiating grease 28 is included between the refrigerant storage member 10 and the substrate 20.

Moreover, according to the sixth embodiment of the present invention, which is shown in FIGS. 15a and 15b, the LED lamp can be structured in such a manner that the LED lamp can be substituted for a street lamp.

In order to achieve this, the refrigerant storage member 10 has a pipe-shape having a predetermined curve, and refrigerant 90 is stored in the interior of the refrigerant storage member 10. One end of the refrigerant storage member 10 is fixedly assembled with an upper part of a post 70 installed in such a manner that it has a predetermined height. A plurality of substrates 20 are fixedly installed at the other end of the refrigerant storage member 10 in a lower direction.

Also, it is preferable that a plurality of radiating plates 34 for increasing radiation effect is integrally formed at an outer circumferential surface of the refrigerant storage member 10 having a pipe-shape. The substrate 20 is provided with a predetermined power through a connecting wire (not shown) installed at the post 70 and an inner surface or an outer surface of the refrigerant storage member 10.

Also, in the modified LED lamp according to the sixth embodiment of the present invention, which is illustrated in FIG. 16, the refrigerant storage member 10 having a pipe-shape can have a sectional shape formed by a roughly closed and curved line. Therefore, refrigerant 90 stored in the interior of the refrigerant storage member 10 is heated through the substrate 20 including LEDs 22 and performs a circulation operation so that radiation can be easily achieved.

Subsequently, the operation of the present invention structured as described above will be described below with reference to the accompanying drawings.

First, according to the first and second embodiments of the present invention, the LED lamp is formed in such a manner that the substrate 20 including high-brightness LEDs 22 is attached onto a lower side of an outer circumferential surface of the refrigerant storage member 10 having a roughly cylindrical shape or is attached onto the outer circumferential surface of the refrigerant storage member 10 along a longitudinal direction thereof, Then, the LED lamp is fixedly installed at a predetermined spot by means of the assembling bracket 12. Accordingly, as power is supplied to the LED lamp through the power part 26, the LED lamp can be used as a lighting apparatus having a superior optical efficiency.

That is, if predetermined power is supplied from the outside to the substrate 20 in a state where the LED lamp is fixedly installed at the predetermined spot, while the high brightness LEDs installed at the substrate 20 are driven, light with high intensity of radiation is emitted to the outside. At this time, heat with a high temperature, which is generated when the high brightness LEDs 22 are driven, is transferred to refrigerant including water, oil, etc. stored in the interior of the refrigerant storage member 10 through the substrate 20 and a contact surface of the refrigerant storage member 10, which is in contact with the substrate 20.

Accordingly, as the temperature of refrigerant, which is positioned at a lower part adjacent to the substrate 20 among refrigerant stored within the refrigerant storage member 10, increases, the refrigerant moves to an upper side of the interior of the refrigerant storage member 10. Also, comparatively cold refrigerant of the upper side of the refrigerant storage member 10 moves to a lower side of the refrigerant storage member. Therefore, due to a convectional phenomenon according to laws of natural, a circulation is repeatedly performed.

Also, as the temperature of refrigerant increases due to radiation of the high-brightness LEDs, the temperature of the refrigerant moved to the upper side of the refrigerant storage member 10 decreases while the refrigerant emits heat by means of the radiating member 30 installed along the outer circumferential surface of the refrigerant storage member 10. Then, the refrigerant again moves to the lower side so as to absorb heat generated according to driving of the high-brightness LEDs. Accordingly, a temperature of heat radiated according to driving of the high-brightness LEDs is uniformly maintained below 50° C. so as not to give negative effects on the life of each high-brightness LED.

At this time, in the first embodiment of the present invention, the high-brightness LEDs 22 are installed along the outer circumferential surface of the refrigerant storage member 10, which is formed at 360 degrees. Therefore, it is possible to irradiate light in entire directions) (360°. In another embodiment of the present invention, light with high intensity of radiation is irradiated to the lower side at a predetermine angle (approximate 270°).

Moreover, the LED lamp includes the lamp shade 40 additionally formed in a boundary between the substrate 20 and the radiating member 30. Therefore, it is possible to radiate light to the lower side in a more efficient manner.

According to the third embodiment of the present invention, after an LED lamp is formed in such a manner that a substrate 20 is installed at a lower part of a refrigerant storage member 10 having a predetermined shape, if the refrigerant storage member 10 is installed at a spot on the telephone pole, which has a predetermined height, it is possible to substitute the LED lamp, which shows a superior radiation effect according to the radiation action of refrigerant kept in the refrigerant storage member 10 and the radiation member 30 as described above, for a street lamp. As a result, the LED lamp can be provided as a street lamp, which can radiate much superior intensity of radiation, and has a long life span.

Also, according to the fourth embodiment of the present invention shown in FIGS. 12a to 12c, after a water cooling-type LED lamp is formed in such a manner that the substrate 20 is installed at a lower part of the refrigerant storage member 10 having a rough bottle-shape, the assembling part 16 of the LED lamp is assembled with a socket for an incandescent lamp. As a result, the LED lamp can be substituted for an incandescent lamp.

That is, after the LED lamp is installed, power is supplied to the substrate 20 through the assembling part 16 and the connecting wire 19 by operating a predetermined switch. Therefore, the LED 22 installed at the substrate 20 is driven so as to emit light.

At this time, heat generated according to driving the LED 22 is delivered to refrigerant 90 stored within the refrigerant storage member 10 through the substrate 20 and a lower surface of the refrigerant storage member 10.

Accordingly, as the temperature of refrigerant, which is positioned at a lower part adjacent to the substrate 20 among refrigerant stored within the refrigerant storage member 10, increases, the refrigerant moves to an upper side of the interior of the refrigerant storage member 10. Also, comparatively cold refrigerant of the upper side of the refrigerant storage member 10 moves to a lower side of the refrigerant storage member. Therefore, due to a convectional phenomenal according to laws of natural, a circulation is repeatedly performed.

That is, as the temperature of refrigerant increases due to radiation of the LEDs, the temperature of the refrigerant moved to the upper side of the refrigerant storage member 10 decreases while the refrigerant emits heat through the radiating plates 34. Then, the refrigerant again moves to the lower side so as to absorb heat generated according to driving of the LEDs.

At this time, a plurality of radiating plates 34 and radiation grease 28 are additionally included in the refrigerant storage member 10. Therefore, the LED lamp emits heat while making contact with outer air so that a more efficient radiation operation can be performed. According to the operation described above, the temperature of emitted heat generated in driving the LED 22 is uniformly maintained below 50° C. so as not to give negative effects on the life of each LED 22.

Also, according to the fourth modified embodiment of the present invention shown in the FIGS. 13a to 13c, in a state where the LED lamp is directly installed at a corresponding installation spot by means of the assembling bracket 12 formed at the body of the refrigerant storage member 10, power is directly supplied to the LED lamp through the power input part 18. Accordingly, a superior optical source and a radiation effect, which are described above, can be obtained.

Meanwhile, as shown in FIGS. 14a to 16, in a case where the LED lamp according to the present invention is applied to various kinds of decoration lamps, fluorescent lamps, street lamps, etc., similarly to the embodiment described above, heat generated according to driving of the LEDs 22 is transferred to refrigerant 90 stored within the refrigerant storage member through the substrate 20 and the lower surface of the refrigerant storage member 10. Then, radiation can be smoothly performed due to the circulation operation of the refrigerant 90, and radiation effect can be also maximized by means of the radiating grease 28 and the plurality of radiating plates 34.

Meanwhile, although other modified embodiments different from the embodiments of the present invention are shown, the modified embodiments are not separately understood departing from the scope and spirit of the invention as disclosed in the accompanying claims.

That is, the LED lamp according to the present invention can be variously applied to various kinds of work lamps, lighthouses, search lights, etc., in addition to incandescent lamps, fluorescent lamps, and street lights through change of design of the LED lamp. Also, it is possible to change the volume of each LED, the number of LEDs, etc., which are used as an optical source, according to an environment where a corresponding LED is used.

1. An LED lamp comprising:
a refrigerant storage member, which has a predetermined space formed in an airtight interior of the refrigerant storage member and stores refrigerant for radiation in the space part, the refrigerant storage member having a cylindrical shape; and
PCB substrates, which have a plurality of high brightness LEDs installed at each upper surface of the PCB substrates and are attached onto an outer circumferential surface of the refrigerant storage member by means of a radiating tape in such a manner that the PCB substrates surround the outer circumferential surface in a state where the LEDs are designed to be supplied with power.

2. The LED lamp as claimed in claim 1, wherein each substrate is formed at a lower part of the outer circumferential surface of the refrigerant storage member, a radiating member, which has a body of a pipe-shape and radiating plates extending from an outer circumferential surface of the body while having each protruding shape, is formed at an upper part of the outer circumferential surface of the refrigerant storage member, and a lamp shade is formed at a boundary between the substrate and the radiating member.

3. An LED lamp comprising:
a refrigerant storage member, which has a predetermined space part formed in an airtight interior of the refrigerant storage member and stores refrigerant for radiation in the space part, the refrigerant storage member having a cylindrical shape; and
PCB substrates, which have a plurality of high brightness LEDs installed at each upper surface of the PCB substrates and are attached onto a part of an outer circumferential surface of the refrigerant storage member along a longitudinal direction of the refrigerant storage member in a state where the LEDs are designed to be supplied with power.

4. The LED lamp as claimed in claim 3, wherein a radiating member, which has a body of a roughly semi-circular shape and radiating plates extending from an outer circumferential surface of the body while having each protruding shape, is formed at a part of the refrigerant storage member onto which the substrates are not attached.

5. The LED lamp as claimed in claim 3, wherein the substrates are attached onto a part of the outer circumferential surface of the refrigerant storage member, which is formed at a range of 120°, the radiating member includes a pair of members, which are attached onto each part of the outer circumferential surface of the refrigerant storage member, the each part corresponding to the range of 120°, and one of the radiating plates of the radiating member, which is adjacent to the substrates, has a width extending out so as to perform a function as a lamp shade.

6. The LED lamp as claimed in claim 3, wherein a plurality of assembling members is formed between the radiating plates positioned at each of both ends of the radiating member, and finishing members, which have a disc-shape and have assembling holes corresponding to the assembling members and a plurality of heat emitting holes, are fixedly assembled with both ends of the refrigerant storage member.

7. An LED lamp comprising:
a refrigerant storage member, which has a predetermined space part formed in an airtight interior of the refrigerant storage member and stores refrigerant for radiation in the space part, the refrigerant storage member having a front surface having a shape of [symbol] and having a section of a circular shape or a rectangular shape; and
PCB substrates, which have a plurality of high brightness LEDs formed on an upper surface of each PCB substrate and are attached onto an outer circumferential surface of a lower side of the refrigerant storage member of the circular shape, or are attached onto a lower surface of the refrigerant storage member of the rectangular shape in a state where the LEDs are designed to be supplied with power,
wherein the LED lamp is installed at an upper side of a telephone pole or a post having a predetermined height by means of steel bands.

8. The LED lamp as claimed in claim 7, wherein a radiating member is formed at a part of the refrigerant storage member having a section of a circular shape, onto which the substrates are not attached, and one of radiating plates of the radiating member, which is adjacent to the substrates, has a width extending out so as to perform a function as a lamp shade.

9. The LED lamp as claimed in claim 7, wherein an extending member integrally extends from a front end of the refrigerant storage member in such a manner that an inner space of the extending member communicates with an inner space of the refrigerant storage member so that an entire plane of the refrigerant storage member has a rough shape of “├”, and in this state, each substrate having the plurality of high brightness LEDs is attached onto a lower surface of the extending member.

10. An LED lamp comprising:
a refrigerant storage member, which has a predetermined space part formed in an airtight interior of the refrigerant storage member and stores refrigerant for radiation in the space part; and
PCB substrates, which are formed by aluminum plates, have one to a plurality of high brightness LEDs installed at each PCB substrate, and are attached onto a lower surface of the refrigerant storage member in a state where the LEDs are designed to be supplied with power.

11. The LED lamp as claimed in claim 10, wherein the refrigerant storage member is made from a metal, such as copper, titanium, aluminum, etc., refrigerant stored within the refrigerant storage member may be liquid, such as antifreezing solution, distilled water, ionized water, etc., and a plurality of radiating plates is formed at an outer surface of the refrigerant storage member, the radiating plates being made from material equal to material of the refrigerant storage member.

12. The LED lamp as claimed in claim 10, wherein the refrigerant storage member has a bottle-shape and includes an assembling part, which is assembled with a socket, formed at an upper end of the refrigerant storage member, the assembling part is connected with the substrate so as to supply predetermined power to the LEDs, and a converter for converting high voltage from the assembling part to low voltage so as to supply the low voltage to the LEDs is included in the substrate.

13. The LED lamp as claimed in claim 10, wherein the refrigerant storage member has a bottle-shape and includes a pair of assembling brackets protruding from one side of the refrigerant storage member, and a power input part for directly supply DC power of 12 [V] to the substrate is included in one side of the refrigerant storage member.

14. The LED lamp as claimed in claim 10, wherein the refrigerant storage member has a broad and cylindrical shape or a rectangular parallelepiped-shape and includes an assembling bracket protruding from one side of the refrigerant storage member, and a plurality of substrates, which has LEDs emitting light by means of power from a power part, is arranged and attached onto a lower surface of the refrigerant storage member.

15. The LED lamp as claimed in claim 10, wherein the refrigerant storage member has a pipe-shape having a predetermined curved line and has one end, onto which a substrate attached in a lower direction, and another end assembled with a post having a predetermined height.

16. The LED lamp as claimed in claim 4, wherein a plurality of assembling members is formed between the radiating plates positioned at each of both ends of the radiating member, and finishing members, which have a disc-shape and have assembling holes corresponding to the assembling members and a plurality of heat emitting holes, are fixedly assembled with both ends of the refrigerant storage member.

17. The LED lamp as claimed in claim 5, wherein a plurality of assembling members is formed between the radiating plates positioned at each of both ends of the radiating member, and finishing members, which have a disc-shape and have assembling holes corresponding to the assembling members and a plurality of heat emitting holes, are fixedly assembled with both ends of the refrigerant storage member.
